(19) United States
(12) Patent Application Publication
(10) Pub. No.: US 2010/0054382 A1
(43) Pub. Date: Mar. 4, 2010

(54) Recovering Data From An Oversampled Bit Stream With A Plesiochronous Receiver

(76) Inventors: Ryan John Kinnerk, Ovens (IE); Aedan Diarmid Cailean Coffey, Kilkenny (IE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/199,406

(22) Filed: Aug. 27, 2008

(51) Int. Cl. H04L 7/00

(52) U.S. Cl. 375/355; 375/316

(57) ABSTRACT

Data is recovered in a plesiochronous receiver from an oversampled bit stream. In one example, a bit stream is received and oversampled in blocks to produce successive sets of samples, each set of samples representing a same number of bits. Transitions are found in the samples. Positions of the found transitions are determined and a single mask of a plurality of masks is selected. The selected mask is applied to the set of samples to determine values for the block of bits.

### FIELD

The present description pertains to the field of recovering data from an oversampled digital bit stream and, in particular, to selecting an appropriate mask such that even data with considerable amounts of jitter, drift and other signal anomalies can be reliably extracted.

### BACKGROUND

Digital communications equipment operates by sending streams of digital data from one device to another. For a simple binary serial data stream, the receiver determines the value for each bit by sampling the signal at intervals. At each interval, the signal represents either a zero or one. However, in real world applications, the two devices are never perfectly synchronized and the timing of the signal is altered as it travels such that the stream of bits does not line up with the sampling interval.

If the sender and the receiver are running at about the same speed, but are not frequency locked, then the system is called plesiochronous. Such a system can be subject to jitter and drift. Jitter occurs when the interval between each bit changes so that some bits are closer together and others are further apart. Drift occurs when the sender has a consistently higher or lower operating frequency than the receiver. The bits are all either too close together or too far apart over a longer period of time. The drift can be unidirectional, in which case one clock is simply slower or faster than the other, or can be bidirectional in which case the interval drifts slowly in one direction and then back again in the other direction.

In some high speed communications systems, such as the standards for SATA (Serial Advanced Technology Attachment), the sender oscillates between two different similar speeds. The data rate changes from 3.0 Gbps (Gigabits per second) to a speed that is about 5000 ppm (parts per million) slower or 2.985 Gbps and back again. In order to ensure that the frequency mismatch between the receiver and transmitter is kept to an absolute minimum some implementations have the receiver operating at a speed between the two or 2.9925 Gbps. As a result the transmitter will drift ahead of the receiver and then drift behind the receiver as the transmitter frequency oscillates between 3.0 Gbps and 2.985 Gbps while the receiver frequency remains fixed at 2.9925 Gbps.

Jitter and drift make it more difficult for a receiver to recover the stream of bits that was transmitted. As the data frequency, or speed of the bits, increases, the difficulty in accurately recovering a bit stream increases proportionally.

### BRIEF DESCRIPTION OF THE DRAWINGS

Embodiments of the present invention are illustrated by way of example, and not limitation, in the figures of the accompanying drawings in which like reference numbers are used to refer to like features, and in which:

FIG. 1 is a block diagram of a plesiochronous transmitter and receiver suitable for application to the present invention;

FIG. 2A is a diagram of applying a mask to select samples from a sample stream according to an embodiment of the present invention;

FIG. 2B is a diagram of applying a second mask to select samples from a sample stream according to an embodiment of the present invention;

FIG. 2C is a diagram of applying a third mask to select samples from a sample stream according to an embodiment of the present invention;

FIG. 2D is a diagram of applying a fourth mask to select samples from a sample stream according to an embodiment of the present invention;

FIG. 2E is a diagram of applying a fifth mask to select samples from a sample stream according to an embodiment of the present invention;

FIG. 3 is a diagram of a sample stream with four transitions in three different positions;

FIG. 4 is a diagram of a second sample stream with four transitions in two different positions;

FIG. 5 is a process flow diagram of recovering a data sequence from a sample stream according to an embodiment of the present invention;

FIG. 6 is a diagram of a clock and data recovery unit according to an embodiment of the present invention;

FIG. 7 is a block diagram of a system on a chip incorporating a clock data and recovery unit according to an embodiment of the present invention; and

FIG. 8 is a block diagram of a physical interface unit of FIG. 7 according to an embodiment of the present invention.

### DETAILED DESCRIPTION

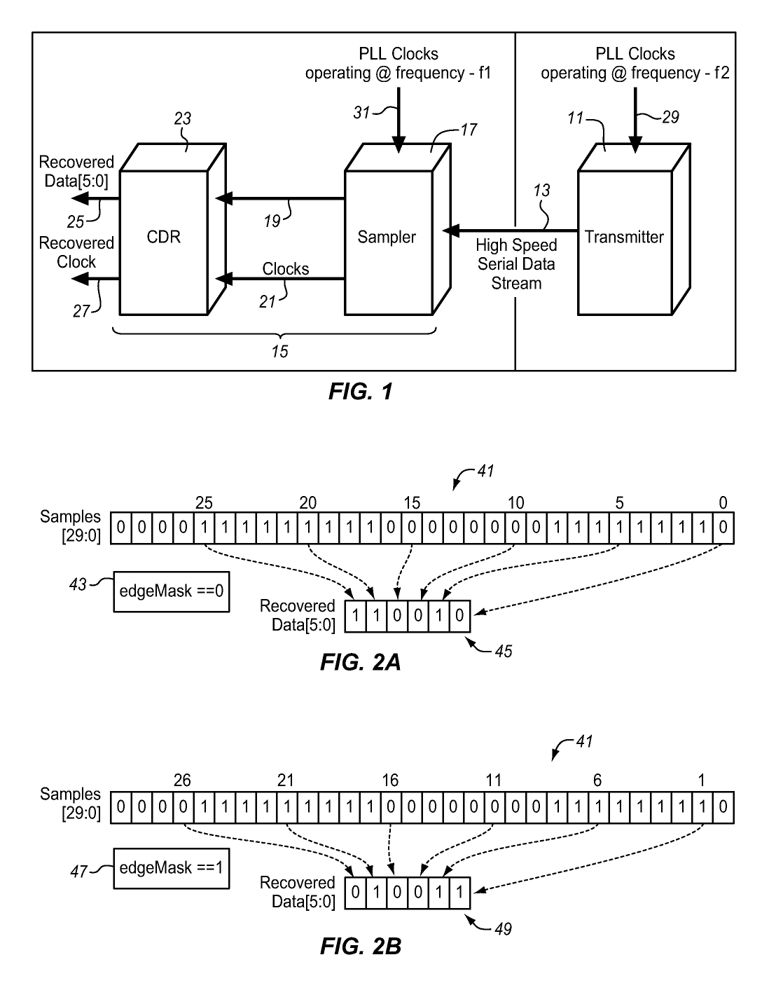

FIG. 1 is a block diagram of a data receiving system. In the illustrated system, there is a transmitter 11, which sends a stream of bits. The bits may come from any of a variety of different sources including magnetic, optical, or semiconductor memory, a remote network, broadcast media, processing operations, etc. The data in this example is sent over a high speed serial digital connection. Any type of connection may be used, depending on the context. In the described example, a SATA (Serial Advanced Technology Attachment) or PCI Express (Peripheral Component Interconnect) connection may be used. However, there are a wide range of serial connections and communications protocols to which different embodiments of the present invention may be applied, including SAS (Serial Attached SCSI (Small Computer System Interface)), Ethernet, and other high speed data storage and communication interfaces.

While the communication is described as high speed, the speed of the connection will also depend upon the type of communications protocol. Embodiments of the present invention have been tested at speeds of at and about 3.0 Gigabits per second, however, embodiments of the invention may be adapted to higher and lower speeds.

The high speed serial data is received by a receiver 15 at a sampler 17. The sampler receives the bit stream and samples it at some predetermined regular interval. The interval is determined based on a clock 31 that regulates the operation of the sampler and is also determined based on the anticipated bit rate of the received bit stream. The sampler oversamples the bit stream so that there is more than one sample for each bit. In the example described below the bit stream is five times oversampled, yielding five samples for each bit. However, the sampling rate may be adapted to suit any particular application.

In many situations, the exact number of samples per bit may vary over time. While the sampler has a clock 31 which controls the rate at which it samples the data, the transmitter is also coupled to a clock 29 that controls the rate at which it sends its bits. If the clocks are not frequency locked, then the number of samples per bit may change due to drift between the clocks as well as a number of forms of real world jitter including intersymbol interference (ISI), duty-cycle distortion (DCD) and crosstalk. In a five times oversampled system, depending on both the amount of drift between the transmitter and receiver and the amount of jitter the data stream is subjected to, any one bit may theoretically be represented by between 1 and 9 samples.

The sampler produces an oversampled bit stream or stream of samples 19 and a clock 21 to accompany the samples. The clock 21 is synchronized to the sample rate and the rate at which the samples are output. The sample stream clock is derived from the input clock 31 for the sampler. The samples are received in a clock and data recovery (CDR) unit 23.

The clock and data recovery unit 23 analyzes the samples to recover the values for the bit stream that was originally transmitted. This is produced as the recovered data 25 and a recovered clock for the recovered data 27. In the described example, the received serial bit stream 13 is recovered in blocks and the blocks are provided in parallel as a parallel bit stream 25 during the recovery process. The parallel bit stream may be aggregated into larger or smaller parallel blocks, or alternatively, it may be serialized and produced as a serial bit stream.

In a plesiochronous system, as shown in FIG. 1, it may be difficult to recover the data when the input bit stream 13 is jittery. In the example described below, the serial bit stream is five times oversampled and the CDR produces 6 bits of parallel recovered data. However, the same approach may be used in many alternative widths at the input of the CDR as well as alternative data bus widths at the output of the CDR. In SATA, for example, 10 bit blocks are standardized. This may be produced by recovering blocks of 10 bit are of some other size and then aggregating or separating bits into groups of 10.

Since the system is five times oversampled, 30 samples nominally represent 6 bits of data. In each block of 30 samples, were the transmitter and receiver frequency locked, there would be a maximum of 5 transitions. Given that the transmitter may in fact be operating at a frequency less than that of the receiver then there may be up to 6 transitions in the 30 bit oversampled bit stream. There may also be fewer transitions if a bit is repeated in the received serial bit stream. A transition refers to a change either from “0” to “1” (01 transition) or from “1” to “0” (10 transition) in adjacent bits in the oversampled bit stream. The approach described herein may also be applied to trinary, quaternary and other types of bit streams in which case there may be more different types of transitions. Alternatively, the sampler may convert such serial streams to binary streams for processing as described below.

In order to recover the original data from the sample stream, embodiments of the present invention determine which of the five samples representing each bit will be extracted as the recovered data bit. For illustration purposes, a signal mask (called edgeMask herein) is used to select the samples to be used as the recovered data bits. In this example of 5 times oversampling, there are five possible values of edgeMask. Each edgeMask represents a data extraction alignment or position. Each possible value edgeMask signal uses a different sample to represent the six recovered data bits and each sample is spaced by exactly one bit, or five samples, from adjacent samples used as the extracted data.

The five possible values of edgeMask and the samples subsequently used as the extracted data are shown in Table 1 in which the numbers in parentheses each identify one of the 30 samples, numbered from 0 to 29:

TABLE 1

| | |
|---|---|
| edgeMask 0 | samples (0, 5, 10, 15, 20, 25) |
| edgeMask 1 | samples (1, 6, 11, 16, 21, 26) |
| edgeMask 2 | samples (2, 7, 12, 17, 22, 27) |
| edgeMask 3 | samples (3, 8, 13, 18, 23, 28) |
| edgeMask 4 | samples (4, 9, 14, 19, 24, 29) |

The masks may be adapted to suit different sample rates and different size blocks, depending upon the particular implementation.

Since the system is five times over-sampled, if there is no clock jitter or drift between the transmitter 11 and the receiver 15, then the samples used as the recovered data bits will be evenly spaced 5 samples apart. Accordingly, a single mask may be used for all six bits. Using any one mask, there will be five samples between each of the samples used to represent the six recovered data bits. In addition, if there is no clock jitter or drift then any of the masks may be used to recover the data.

However, if there is jitter or drift then only some of the masks, or in some cases only a single edgeMask value, will produce an accurate representation of the originally transmitted six bits. By selecting an appropriate mask to extract all six bits from the sample stream, the data recovery is rendered jitter and drift tolerant. In a typical real system, there will be two or three masks that will provide accurate data recovery and an appropriate mask will be adjacent to or nearly adjacent to an appropriate mask for the last recovered block of six bits. Embodiments of the present invention may be thought of as determining an appropriate next state value of edgeMask such that the serial data may be reliably recovered from a jittery oversampled bit stream in a plesiochronous system.

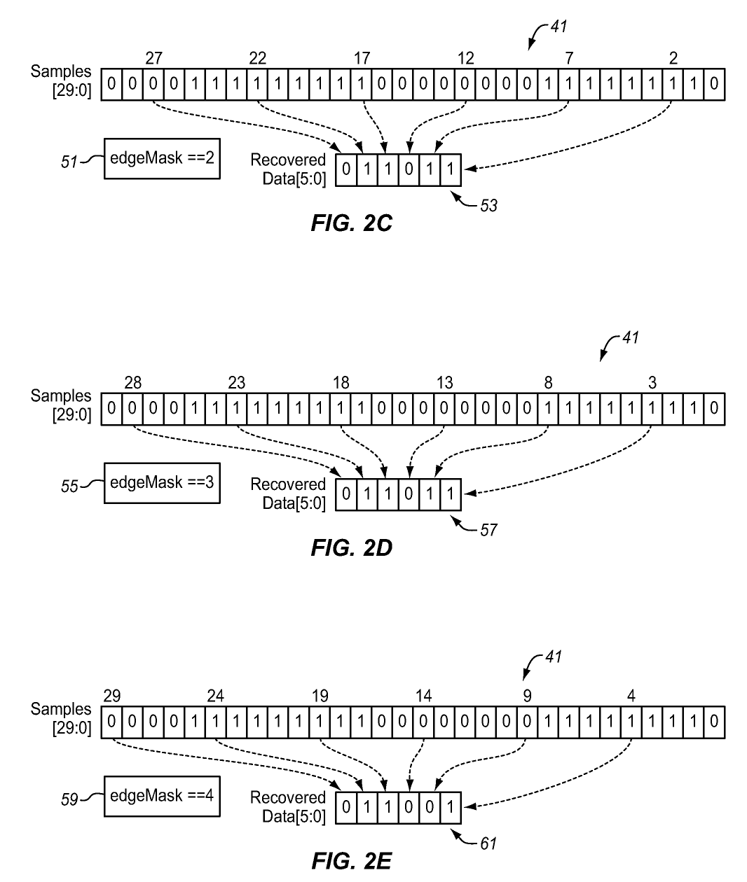

FIG. 2A shows an example jittery block of samples. As discussed above, in this particular example, there are 30 samples, numbered from 0 to 29, for the block of six bits. A close look at the sample stream from right to left reveals that the zeroth bit is 0. There is a transition from the zeroth sample to the first sample from 0 to 1. The samples continue at 1 until the eighth sample and sample nine is 0 again. The 0's continue until sample seventeen which returns to 1 and the 1's continue until sample 26 which is again 0. The last four samples 26-29 are 0. In other words, the sample stream of FIG. 2A has transitions at [26:25], [17:16], [9:8], and [1:0]. Visual inspection suggests that the six bit block might be recovered as either (011001) or (011011). However, this may not be what was transmitted.

FIG. 2A also shows diagrammatically, the application of edgeMask0 to the sample stream. This results in the values at positions 25, 20, 15, 10, 5, and 0 being read to produce (110010) identified by reference number 45.

FIG. 2B is a diagram of the application of edgeMask1 47 to the same sample stream 41. This results in the values at positions 26, 21, 16, 11, 6, and 1 being read to produce (010011) identified by reference number 49.

Similarly, FIG. 2C is a diagram of the application of edgeMask2 51 to the same sample stream 41. This results in the values at positions 26, 21, 16, 11, 6, and 1 being read to produce (011011) identified by reference number 53.

Similarly, FIG. 2D is a diagram of the application of edgeMask3 55 to the same sample stream 41. This results in the values at positions 26, 21, 16, 11, 6, and 1 being read to produce (011011) identified by reference number 57.

Similarly, FIG. 2E is a diagram of the application of edgeMask4 59 to the same sample stream 41. This results in the values at positions 26, 21, 16, 11, 6, and 1 being read to produce (011001) identified by reference number 61.

As shown by comparison of the different results, the five masks produced four different results. The choice of mask can significantly affect the resulting output recovered data. In this particular example, there is a lot of jitter in the sample stream and the data is therefore difficult to extract but if the current value of edgeMask were known, an appropriate next state value of edgeMask could be determined.

CDR (Clock and Data Recovery) can be viewed in terms of determining the positions for the transitions. As mentioned above, for the example sample stream shown in FIGS. 2A to 2E, the transitions occur at the positions shown in Table 2. Table 2 also shows the transitions considered by each of the edgeMask signals.

TABLE 2

| | | | | | | | |
|---|---|---|---|---|---|---|---|
| stream 41 | [26:25], | | [17:16], | | [9:8], | [1:0] | |
| edgeMask0 | [26:25] | [21:20] | [16:15] | [11:10] | [6:5] | [1:0] | position 0 |
| edgeMask1 | [27:26] | [22:21] | [17:16] | [12:11] | [7:6] | [2:1] | position 1 |
| edgeMask2 | [28:27] | [23:22] | [18:17] | [13:12] | [8:7] | [3:2] | position 2 |
| edgeMask3 | [29:28] | [24:23] | [19:18] | [14:13] | [9:8] | [4:3] | position 3 |
| edgeMask4 | [0:29] | [25:24] | [20:19] | [15:14] | [10:9] | [5:4] | position 4 |

Each value of edgeMask can be described as being ideal for recovering data with transitions in the corresponding position i.e. if transitions were only occurring in position 0 then edgeMask0 would ideally be used to extract the data. As shown in Table 2, there are four transitions in the sample stream 41 aligned to three different mask signals. Accordingly, in this example, masks 2 and 3 provide the same value for data recovery and the other masks, 0, 1, and 4, each provide different values from each other and from masks 2 and 3.

The mask signal transitions can be mapped to the positions in the sample stream to characterize the transition positions. The first transition [26:25] and the fourth transition [1:0] correspond to position 0 or edgeMask0. The second transition [17:16] corresponds to position 1 or edgeMask1 and the third transition [9:8] corresponds to position 3 or edgeMask3. There are two other positions at which there is no transition because the bit values are repeated and therefore the specific positions of where these transitions would have occurred cannot be determined.

The transition positions may be used to select a mask for data recovery as described in more detail below.

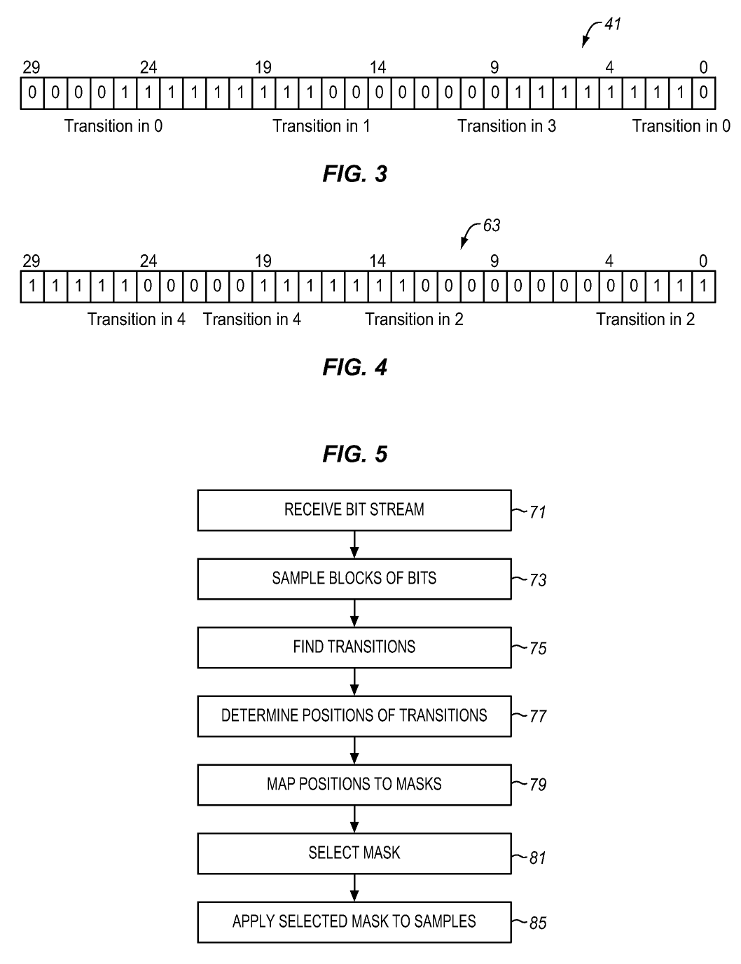

FIG. 3 shows the sample stream 41 of FIGS. 2A to 2E and shows the transition positions as suggested by the edgeMask signals above. The diagram of FIG. 3 shows the each of the four transitions labeled as being in one of position 0, 1 or 3 as mentioned above. This sample stream may be interpreted as having transitions in positions 0, 1, and 3.

FIG. 4 shows a diagram of another sample stream 63 which has transitions at [25:24], [20:19], [13:12], and [3:2]. These transitions occur accordingly at positions 4, 4, 2, and 2 respectively as identified in the figure. Accordingly, this sample stream may be interpreted as having transitions in positions 2 and 4.

FIG. 5 is a process flow diagram for recovering data from a block of samples. At block 71, a bit stream is received from an external source such as the serial transmitter 11 of FIG. 1. However, as mentioned above, the bit stream may be received from a variety of different sources. At block 73, the bits are oversampled in blocks. This produces successive sets of samples in which each set of samples represents the same number of bits. In the examples above, the bit stream is five times oversampled and the blocks are six bits long. This produces set of thirty samples (0-29).

At block 75, a set of samples is analyzed to find the transitions and, at block 77, the position of each transition found in the analysis is determined. At block 79, these positions are then compared to the available masks in order to map a mask to each one of the transitions.

At block 81, a mask is selected based on the determined positions, among other factors and at block 85, the selected mask is applied to the set of samples to determine values for the block of bits. This may then be produced as the recovered data values.

To select an appropriate data mask a variety of different techniques may be used. In one example, the data mask for which there is no corresponding position is selected. A variety of other examples are described below. So, for example, in the example of Table 2, either edgeMask 2 or 4 may be selected.

Note that the sampler stream 41, described above, contains a lot of jitter and it is particularly difficult to determine the original string of bits. Such a sample stream may not represent typical sampling results. The choice between edgeMask 2 or 4 may be based on prior mask selections, a preference for the lower or higher value or any of a variety of other bases.

The operation at block 81 of selecting a mask can also be affected by how the comparing the determined positions are used. The determined positions can be expressed as a sequence of edgeMask values. So, for the example of Table 2, the sequence is (0, 1, 3, 0). This sequence provides the edgeMasks that have a position corresponding to each of the four transitions. If there are more or fewer transitions, then the sequence may be longer or shorter. In one approach, since six bits are expected and there may be up to six transitions, the sequences can all be conformed to a length of six positions. The additional two transitions can be selected in any of a variety of ways using averages, medians, or plotting, for example.

Typically, a transmitter and a receiver are both designed to stay within some maximum amount of jitter and drift. In the example above, 30 samples are being analyzed. A change from one mask to an adjacent mask represents a change corresponding to 1/30 or 3.33% of the clock rate. If the data recovery system never changed the edgeMask value by more than one, then it therefore tolerate a frequency mismatch of up to 33,333 ppm between transmitter and receiver. Since this is more drift than a typical commercial system is allowed, the change of edgeMask value from one block of bits to the next can be limited to a single position.

In this variation of the mask selection, the previous mask state (e.g. edgeMask0 through edgeMask 4) is considered and the current mask is changed by no more than one. So for example, if the edgeMask value was 3 for the previous block of bits, then for the next block of bits, the edgeMask value must be either 2, 3, or 4. 0, and 1 are not allowed. This approach also prevents bad data from significantly upsetting the recovery clock.

If the decision is simplified to either incrementing, decrementing or not changing the selected mask value, then the evaluation of positions may be reduced to a decision of whether the determined positions suggest a change, and if so, in which direction. So, for example if the determined positions are all lower in value than the current mask, then the mask value can be decremented. Similarly if the determined positions are all higher in value than the current mask, then the mask can be incremented. If the determined positions are a combination of lower and higher, or if they are the same as the current mask state or if the average, median or some other value is the same as the current mask state, then the mask state can be left unchanged.

An example of using the determined positions to indicate a direction of change can operate simple and with few computations. If, for example, the current value of edgeMask is 2 and transitions are detected only occurring in position 4 then the next state value of edgeMask would be 3. The edgeMask correction is restricted to one step and the step is taken in the direction of the detected transition. In another example, if the current value of edgeMask is 3 and transitions are detected in positions 1, 2 and 4, then the next state value of edgeMask can be 3 again. In this example, while the detected positions averaged to a value less than three, the distribution of the values did not clearly indicate whether the transitions were happening above (at 4) or below (at 2) the current alignment at 3. On the contrary transitions were happening in both directions.

As illustrated above, in some embodiments, certain combinations of positions may be identified as inconclusive or unreliable and so the mask state is not changed. For example, any combination of positions that would suggest a move in both directions may be ignored and the previous mask state used as the current mask state. In the current example of 5 possible positions from 0 to 4, a lower and higher value can be understood in terms of the clock continuum or in terms of a cycle that goes from 0-4 and loops back again as a modulus. If the current mask state is zero, then positions 1 and 2 would suggest incrementing the mask state. However positions 4 and 3 suggest decrementing the mask state. This is because decrementing the mask state 0 by 1 results in mask state 4. Mask state 4 is therefore closer to 0 than are mask states 2 and 3 which both require a move of 2 or 3 mask states.

For an arithmetical implementation, the absolute value of the sum of the determined positions modulo 5 may be taken and then compared to the current mask state. This result can then be used to decrement, increment, or not change the mask value. Alternatively, the positions may be binned as higher or lower modulo 5, than the current mask state. If the positions are all on one side, then the mask may be changed one step in that direction, while if the positions occur on both sides, then the mask may be left unchanged. This represent two possible implementations, but many others are possible.

For a look-up table implementation, combinations of positions may be applied to a table input and the table output may be an appropriate new edgeMask value. The table can be a table configured for only one possible current edgeMask value. Alternatively the table may have a section or another dimension to allow providing the current edgeMask value as an input. The table results may be determined in advance deterministically or empirically. They may, for example, be calculated using means and averages as mentioned above. As with any of the variations described above, some or all of the determined positions may be used in selecting the new edgeMask value.

In effect, decrementing the mask state is related to slowing the receiver clock, while incrementing the mask state is related to accelerating the receiver clock.

In another embodiment of the invention, given the determined positions, the mask signal is selected using the positions. In one example, a weighted average of the positions is determined. This average is then used to determine the current data alignment for the mask signal or the average is used directly as the mask signal. So, for example, in the Table 2 example, the average value for (0, 1, 3, 0) is 1. The result, 1, can be used as the edgeMask value or as an input into the next step in selecting the mask. As additional illustrations, with transitions in positions 2 and 4, the average is 3. In this case, edgeMask3 is used to read the samples as shown in FIG. 2D. As another example, if the transitions occur at 2, 3, 3, 2, and 2, the average is 2.4, so the selected mask value is 2. As an alternative, the median of the determined positions may be used and then rounded to the closest value to determine the edgeMask.

As a further alternative, the positions may be determined and then, rather than considering a weighted average, the number of occurrences is ignored and instead each position is considered only once. In the Table 2 example, the sequence (0, 1, 3, 0) becomes (0, 1, 3) and the average is now 1.3. This change may or may not affect the result depending on the determined positions, but it does reduce computational complexity. In the example above in which the transitions are at (2, 3, 3, 2, 2), the repetitions are ignored and only the values of (2, 3) are considered. The average is 2.5 and so either edgeMask2 or edgeMask3 may be selected. While the result is similar to the above example, with different position determinations, different results may be obtained.

In the above examples, the current (or previous) position of edgeMask is ignored. Rather than using the determined positions directly, the previously used edgeMask value may be considered. This adds stability to the data recovery and can avoid erratic system behavior.

Any one or more of the principles discussed above may be combined to arrive at a useful approach to selecting the next mask state and the principles may be combined as desired. Additional factors may also be considered. The decision may be made using hardware logic circuits, a processor implementing logic or instructions, or a lookup table.

As an alternative to the example described above, some of the 32 transition position combinations may be ignored for any of a variety of different reasons. In addition, the value of edgeMask for the previous six bit block may be ignored and other additional elements may also, or alternatively, be considered, including the frequency of the detected transition positions.

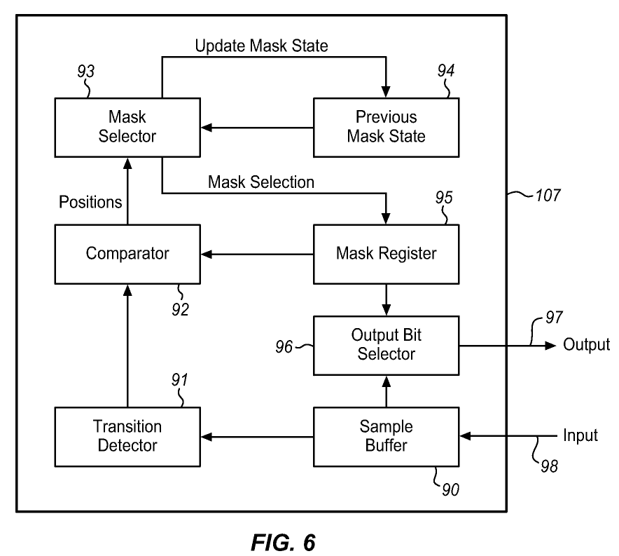

FIG. 6 shows a block diagram of a digital CDR 107 capable of implementing the processes and approaches described above. In FIG. 6, the input samples from an input line 98 arrive at a sample buffer 90 where they are made available for other processes. The samples are provided from the buffer to a transition detector 91 which determines the location of the bit transitions e.g. [1,0], [0,1].

The bit transitions are provided to a comparator 92 which also receives masks from a mask register 95, such as edgeMask0 through edgeMask4 as mentioned above. The masks are compared to the transition positions as represented, for example, in Table 2 to develop a set of positions as in FIGS. 3 and 4. The positions are presented to a mask selector 93 to select a mask to apply to the data for use in recovering the data from the samples.

The mask selection is sent to the mask register 95 that can then provide the mask to an output bit selector 96. The output bit selector applies the mask to the sample buffer 90 as represented in FIGS. 2A to 2E. This causes certain of the samples to be selected to produce the recovered output bits 97.

The mask selection is also fed to a register to store the previous mask state 94. This ensures that the previous mask state is consistently updated. As also shown in FIG. 6 and mentioned above, the previous mask state may also be used by the mask selector 93 in selecting a mask for the current set of samples. The mask may be selected in any of a variety of different ways as described above.

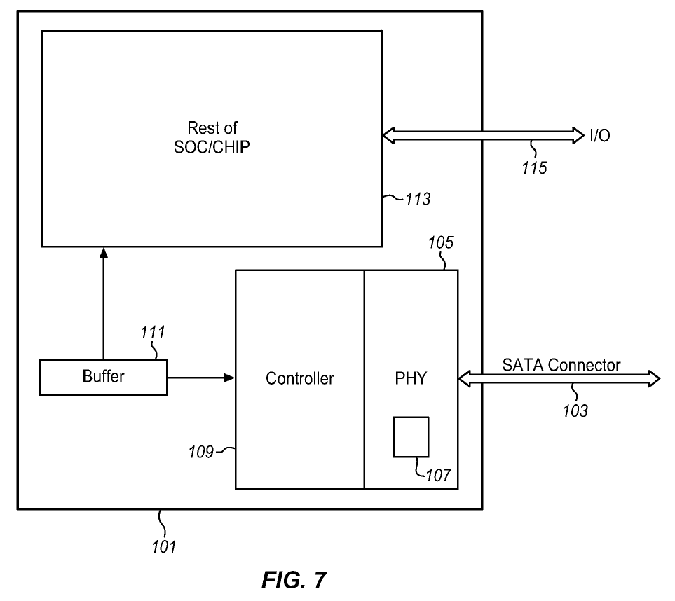

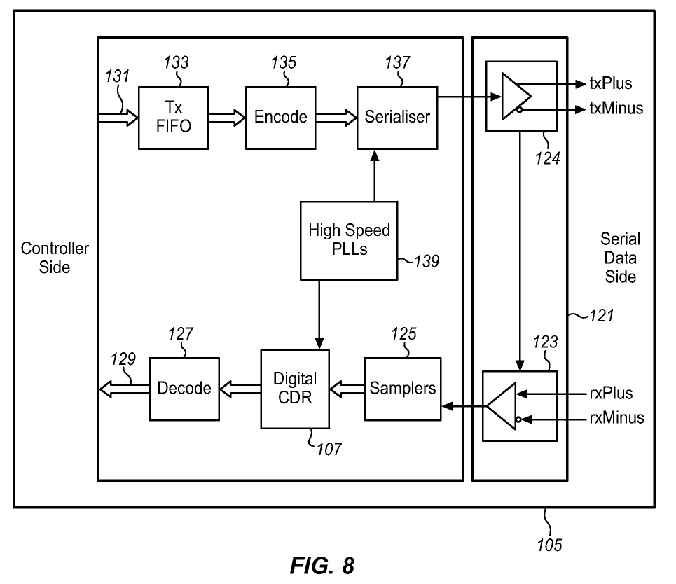

FIG. 7 provides an example of a context for use of the digital CDR described above. In the present example, the CDR 107 is placed in the context of a SOC (System on a Chip) 101, this system may be simple or advanced. The system may be an adapter or bridge, or it may be a storage controller, communications controller or any of a variety of other systems. The approaches described here may also be applied to other contexts.

In the illustrated example, a serial data connector 103, such as a SATA connector as mentioned above, is coupled to a PHY (Physical Layer) Interface 107 that receives and recovers the data. The serial connector 103 is also coupled to one or more external devices, as mentioned above, such as SATA data storage or any other suitable device or devices.

The CDR 107 may be incorporated into the PHY or provided as separate structure. The PHY is coupled to a controller 109 to perform higher level functions on the data, the data protocols, and the serial connector. The controller may also perform higher level functions with the devices on the other side of the serial connector 103 (not shown). The controller is coupled to a buffer 111 that temporarily stores commands and data that are to be sent to and received from the controller.

The controller is coupled through the buffer 111 to the rest of the SOC devices, components and interfaces 113. These may be selected based on the intended use and functions for the system and are not described in detail here in order not to obscure the invention. The SOC further has one or more I/O (Input/Output) interfaces 115 for communication with other external devices.

FIG. 8 is a block diagram of the PHY 105 of FIG. 7 showing some of the components in more detail. In this and all of the diagrams, certain details are not included in order to avoid obscuring details of the present invention. The PHY includes a serial connection interface 121 with a receiver interface 123 for receiving differential serial data signals and providing them as baseband equalized data for a sampler 125. Similarly, the connection interface has a transmitter interface 124 for converting the received bit stream into differential signals for transmission to the external device. The particular nature of the interface connector depends upon the type of interface. This example may be suitable for a SATA connector 103 or a PCI Express or SAS connector, among others.

The sampler 125, connected to receive serial data through the serial connection 123 from the external device or devices, is also connected to the CDR 107. The CDR recovers data and clock as described above and sends the recovered data to a decoder 127 that decodes the six bit blocks into a format suitable for the rest of the system. The decoder is then coupled to an external connector 129 to send the recovered data to other systems. In the example of FIG. 7, this other system is the controller 109.

In the opposite direction, data from the controller is received through a transmit interface 131 in the PHY 105 at a transmit buffer 133 such as a FIFO (First In First Out) buffer. This data is sent to an encoder 135 to encode the data as is appropriate for the particular serial connection. The encoded data is transmitted to a serializer 137 to convert the data to an appropriate format for transmission through the transmit interface 124.

The serializer 137 and the CDR 107 are clocked by a reference clock 139. The clock may contain high speed PLLs (Phase Locked Loops) or other devices. The clock is adapted for the particular serial connector for which the system is adapted. However, as mentioned above, the clock is not synchronized to the clock of the external devices at the other end of the serial connection.

A variety of other controllers, physical interfaces and connectors may be used other than those shown and described herein. Therefore, the configurations may vary from implementation to implementation depending upon numerous factors, such as price constraints, performance requirements, technological improvements, or other circumstances. Embodiments of the present invention may also be applied to other types of communications interfaces and electronic systems that use different protocols and hardware architectures than those shown and described herein. While the description above refers primarily to SATA and PCI Express, the invention is not so limited and may be applied to a wide range of other systems and technologies.

In the description above, numerous specific details are set forth. However, embodiments of the invention may be practiced without these specific details. For example, well-known equivalent materials may be substituted in place of those described herein, and similarly, well-known equivalent techniques may be substituted in place of the particular analysis and communication techniques disclosed. In addition, steps and operations may be removed or added to the operations described to improve results or to add additional functions. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
receiving a bit stream;
oversampling blocks of bits from the bit stream to produce successive sets of samples, each set of samples representing a same number of bits;
finding transitions in the samples of a set of samples;
determining positions of the found transitions;
selecting a single mask of a plurality of masks using the determined positions; and
applying the selected mask to the set of samples to determine values for the block of bits.

2. The method of claim 1, further comprising providing the determined values to an external sink as a digital word of parallel bits.

3. The method of claim 1, wherein the masks of the plurality of masks are each based on a same interval between the samples and each mask uses a different start time.

4. The method of claim 1, wherein each mask contains a number of positions corresponding to the oversampling rate, the positions being spaced evenly apart and for each mask, the first position beginning with a different sample than the first position of each other mask.

5. The method of claim 4, wherein selecting a single mask comprises:
relating each determined position of the found transitions to a numerical value;
comparing the related numerical values to a mask used for a previous block of bits; and
selecting a mask having a first position that is one sample different from the mask used for the previous block of bits based on the determined numerical values.

6. The method of claim 5 wherein selecting a mask beginning with either an earlier or later sample comprises selecting a mask beginning with a sample that is no more than one sample apart from a mask used for the previous block of bits.

7. The method of claim 1, wherein selecting a single mask comprises relating each determined position to a numerical value, and averaging the numerical values.

8. The method of claim 1, wherein selecting a mask comprises comparing the determined positions to a previous selected mask and selecting a mask adjacent to the previous mask based on the determined positions, wherein a mask is adjacent to a previous mask if it contains a position within the set of samples adjacent to a position of the previous mask.

9. The method of claim 1, wherein receiving a bit stream comprises receiving a bit stream from an external serial data source.

10. An apparatus comprising
a sampler to receive a bit stream from an external source and to oversample the bit stream to produce successive sets of sample, each set of sample representing a same number of bits; and
a clock and data recovery unit to find transitions in the samples of a set of samples, to determine the positions of the found transitions, to select a single mask of a plurality of masks using the determined positions, and to apply the selected mask to the set of samples to determine values for the block of bits.

11. The apparatus of claim 10, further comprising a decoder to accumulate the blocks of bits into a sequence of parallel digital words.

12. The apparatus of claim 10, wherein the clock and data recovery unit includes a register to store a value indicating a previously selected mask and wherein the previously selected mask is used to select the single mask to apply to the set of samples.

13. The apparatus of claim 12, wherein the clock and data recovery unit selects a single mask by selecting a mask adjacent to the previously selected mask if the determined positions indicate that an earlier or later mask should be selected.

14. The apparatus of claim 12, wherein the clock and data recovery unit comprises a mask selector that applies the previously selected mask and the recovered positions to select a mask using a sequence of logic circuits.

15. The apparatus of claim 10, wherein the clock and data recover unit applies the determined positions to plurality of masks to determine masks corresponding to the positions and selects the single mask based thereon.

16. The apparatus of claim 10, further comprising a clock to time the sampler and wherein the clock and data recovery unit generates a clock recovery signal based on the clock and for use with the values for the block of bits.

17. A method comprising:
oversampling a block of bits from a serial bit source to form a digital sample set;
analyzing the sample set to determine positions of transitions in the samples from one digital value to another;
comparing the transition positions to the transition positions of a mask applied to a previous sample set; to determine whether the transition positions represent an advance or delay compared to the mask applied to the previous sample set;
selecting an edge mask for the sample set based on the comparison.

18. The method of claim 17, wherein comparing comprises comparing the transition positions to sample positions of a plurality of candidate masks to find masks with sample positions that coincide with the transition positions, each mask comprising a set of sample positions.

19. The method of claim 17, wherein the selected edge mask and the mask applied to the previous sample set each comprise a sequence of sample position and wherein selecting an edge mask comprises selecting an edge mask with a sequence of sample positions that is adjacent to or the same as the sample positions of the mask applied to the previous sample set.

20. The method of claim 17, wherein selecting an edge mask comprises applying the transition positions and the mask applied to the previous sample set to a logic circuit.
